(19) United States
(12) Patent Application Publication
(10) Pub. No.: US 2026/0045742 A1
(43) Pub. Date: Feb. 12, 2026

(54) ELECTRICAL CONNECTOR WITH AN IMPROVED GROUNDING MEMBER

(71) Applicants: FUDING PRECISION INDUSTRY (ZHENGSHOU)CO., LTD., Zhengzhou (CN); FOXCONN INTERCONNECT TECHNOLOGY LIMITED, Grand Cayman (KY)

(72) Inventors: HONG-JING LUO, Shenzhen (CN); HUNG-CHENG LIAO, New Taipei (TW); TSU-YANG WU, New Taipei (TW)

(21) Appl. No.: 19/290,959

(22) Filed: Aug. 5, 2025

(30) Foreign Application Priority Data
Aug. 6, 2024 (CN) 202421902163.4

(51) Int. Cl. H01R 13/652; H01R 13/05; H01R 13/506; H01R 13/6581

(52) U.S. Cl. CPC H01R 13/652; H01R 13/05; H01R 13/506; H01R 13/6581

(57) ABSTRACT

An electrical connector includes: an insulative housing including a base portion and a tongue portion; a first row of terminals received in the insulative housing and having a pair of differential signal terminals and a grounding terminal exposed upon the tongue portion; a first grounding member having a grounding portion fixed to the grounding terminal and a shielding portion shielding over the pair of signal terminals; and an insulative block fixed in the shielding portion and facing the pair of differential signal terminals.

### BACKGROUND OF THE INVENTION

### Field of the Invention

The present invention relates to an electrical connector, and particularly to a male connector.

### Description of Related Arts

U.S. Patent Application Publication No. 2023/0170649 discloses an electrical connector including a longitudinal body, a row of first terminals arranged on the body, and a first grounding piece. The row of first terminals includes multiple first signal terminals and multiple first grounding terminals. The first grounding piece extends out a first connection part and a second connection part that contact the same first grounding terminal. The first connection part extends out along the longitudinal direction. The second connection part extends out in a front-back direction perpendicular to the longitudinal direction. In existing technology, the method of adjusting the structure of the grounding component itself is usually adopted to achieve better high-frequency performance of the electrical connector. However, this method is rather complicated in process and has certain limitations in improving the impedance effect.

U.S. Pat. No. 10,741,944 discloses an electrical connector having a grounding member and insulating members mounted to the grounding member. The insulating members which have the dielectric constants greater than that of the air are provided to be in contact with differential signal pairs for reducing the impedance of the differential signal pairs for impedance balancing consideration.

### SUMMARY OF THE INVENTION

An electrical connector comprises: an insulative housing comprising a base portion and a tongue portion extending from the base portion in a mating direction, the tongue portion defining a first surface and a second surface opposite to the first surface; a plurality of terminals comprising a first row of terminals exposed upon the first surface of the tongue portion and a second row of terminals exposed upon the second surface of the tongue portion; and a first grounding member fixed between the first surface and the second surface; wherein the first row of terminals comprise a grounding terminal and a pair of differential signal terminals and each include a contact portion exposed upon the first surface, the first grounding member includes a grounding portion contacting the grounding terminal and a shielding portion facing the pair of signal terminals, the shielding portion has an opening and an insulative block in the opening, and the insulative block is located adjacent to the contact portions of the signal terminals.

### BRIEF DESCRIPTION OF DRAWINGS

FIG. 1 is a perspective view of an electrical connector of an embodiment of this present invention;

FIG. 2 is a top view of the electrical connector;

FIG. 3 is an exploded view of the electrical connector;

FIG. 4 is an exploded view of the electrical connector in FIG. 3 from another perspective;

FIG. 5 is an exploded view of two rows of terminals and grounding members;

FIG. 6 is an exploded view of two rows of terminals and grounding members in FIG. 5 from another perspective;

FIG. 7 is partial front view of the two rows of terminals and the grounding members;

FIG. 8 is the top view of the two rows of terminals and the grounding members;

FIG. 9 is a perspective view of the first grounding member; and

FIG. 10 is a perspective view of a signal terminal.

### DETAILED DESCRIPTION OF THE DRAWINGS

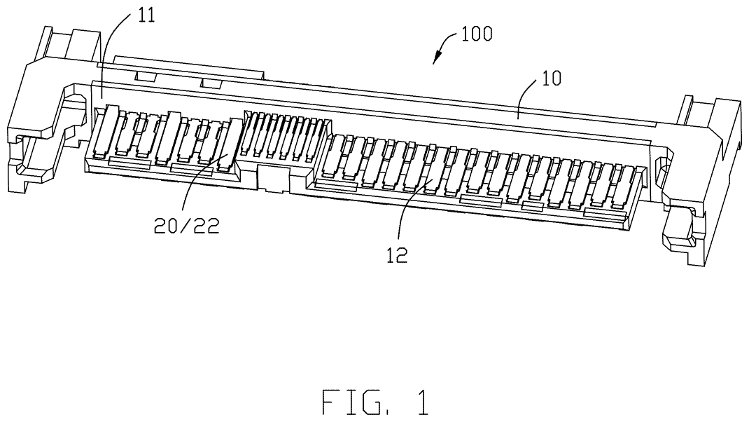

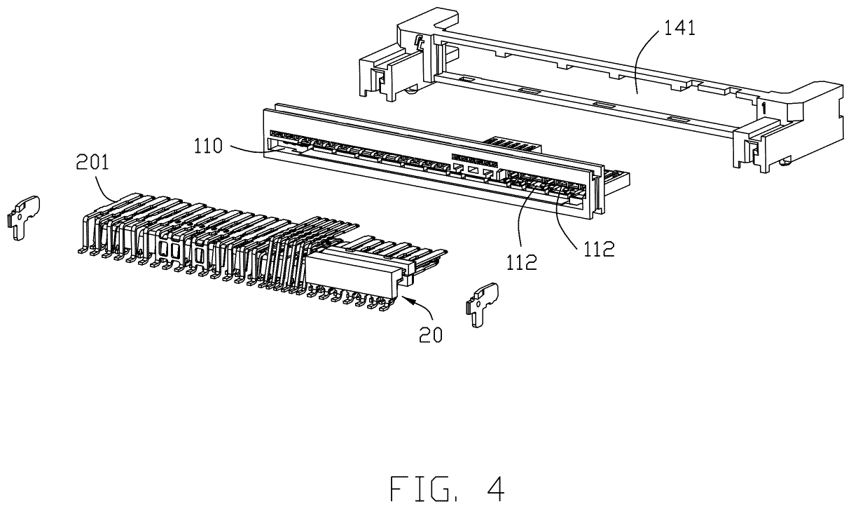

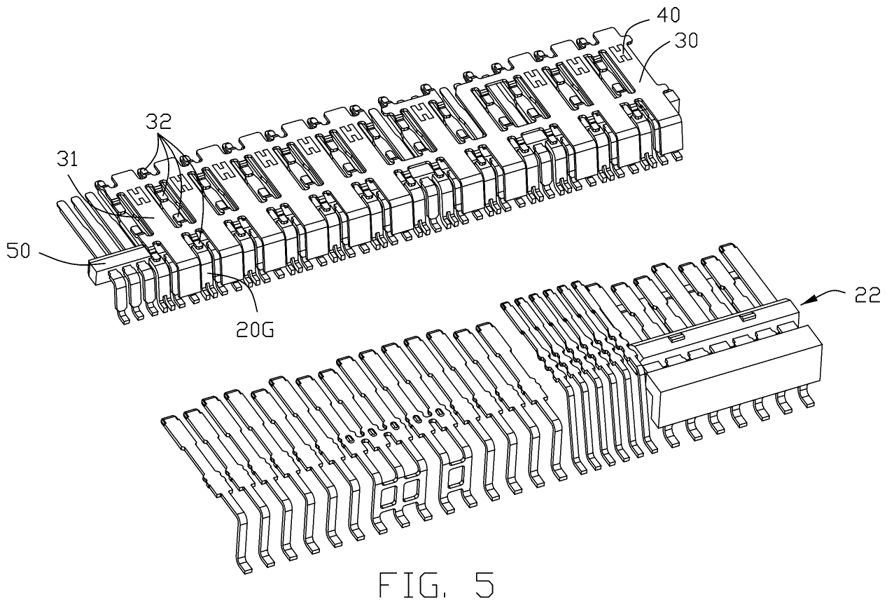

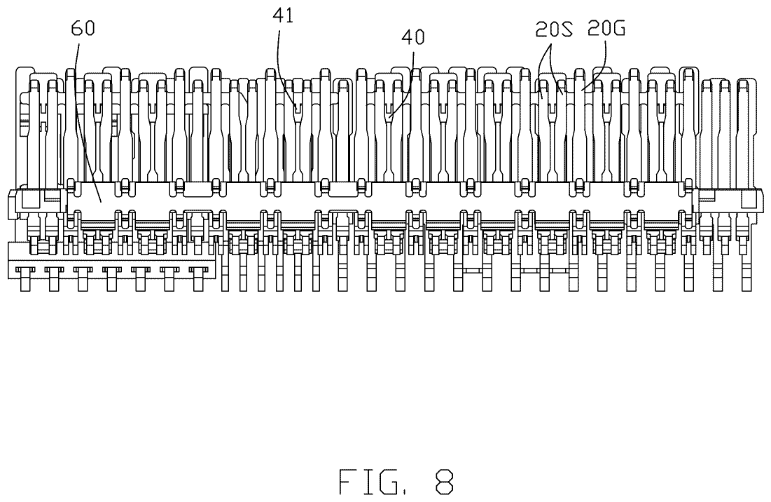

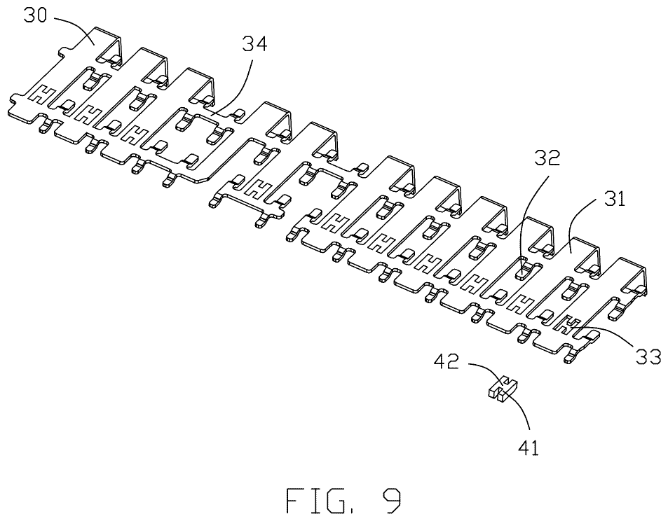

Referring to FIGS. 1-10, an electrical connector 100 comprises an insulative housing 10, a plurality of terminals 20 and multiple grounding members. The insulative housing 10 includes a base portion 11 and a tongue portion 12 extending forward from the base portion 11. The tongue portion 12 has a first surface 121 and a second surface 122 opposite to the first surface 121. Each of the terminals 20 includes a contact portion 201 exposed upon the first surface 121 of the tongue portion 12 and a mounting portion 202 extending out of the base portion 11. The terminals 20 include a first row of terminals 21 exposed upon the first surface 121 of the tongue portion 12. The first row of terminals 21 includes multiple pairs of differential signal terminals 20S and multiple grounding terminals 20G. The first grounding member 30 is contained within the tongue portion 12 and located between the first surface 121 and the second surface 122. The first grounding member 30 includes a plurality of shielding portions 31 respectively facing the pairs of differential signal terminals 20S and a plurality of grounding portions 32 connected to the grounding terminals 20G. Each shielding portion 31 includes an opening 33 and an insulative block 40 fixed within the opening 33. The insulative block 40 is directly facing but not touching the contact portion 201 of one of the pairs of signal terminals 20S to adjust impedance.

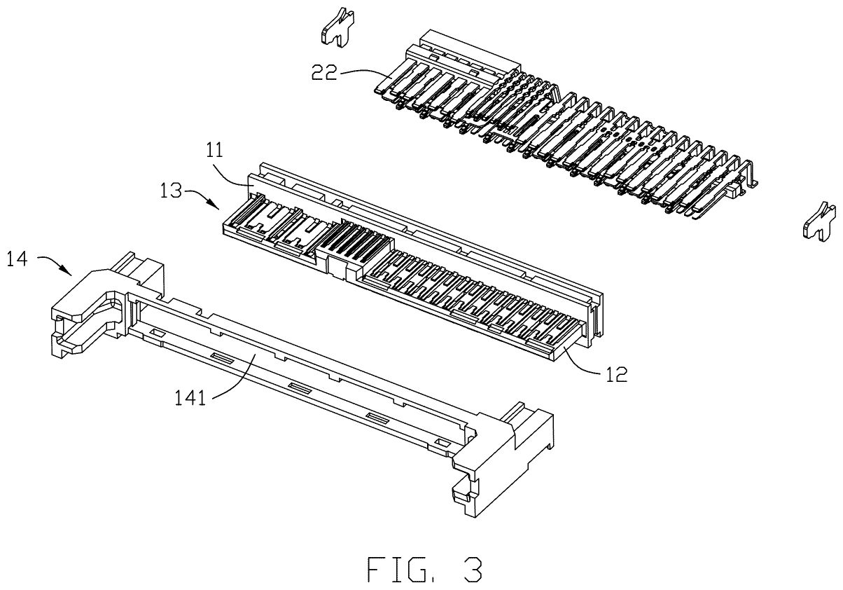

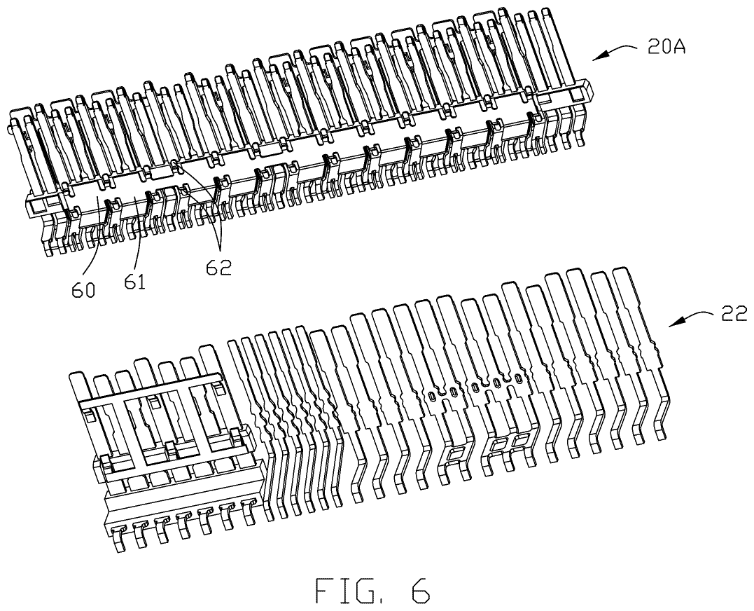

As shown in FIGS. 3-6, the first row of terminals 21 is fixed together by an insulative body 50. The first grounding member 30 is fixed on one side of the first row of terminals 21, and each grounding potion 32 is welded and fixed to one of the grounding terminals 20G, and then the first grounding member 30 and the first row of terminals 21 are inserted together into the insulative housing 10. As shown in FIG. 6, the electrical connector 100 also includes a second grounding member 60 fixed on one side of the insulative body 50 and extends out of the base portion 11 of the insulative housing 10. The second grounding member 60 includes a plurality of shielding portions 61 respectively facing the differential signal terminal pairs 20S and a plurality of grounding portions 62 connected to the grounding terminals 20G. The grounding portions 62 are fixed to the grounding terminals 20G by welding. The welding method for the grounding portions 32 and the grounding portions 62 can be laser welding. Therefore, the first row of terminals 21, the first grounding member 30, the second grounding member 60 and the insulative body 50 form the terminal assembly 70 and are all inserted into the insulative housing 10 together. To be mentioned, ‘the first’ and ‘the second’ in the first and second grounding members are only used to distinguish different grounding members and have no sequence. In some cases, the grounding member only refers to the first grounding member.

The base portion 11 of the insulative housing 10 defines a rearward-opening cavity 110. The insulative body 50 is inserted into the cavity 110 and fixed to it by snap-fit. A plurality of protrusions 51 extends from the surface of the insulative body, and the base portion 11 includes a plurality of slots 111 connected to the containment cavity 110. Protrusion 51 matches slot 111. Thus, the terminal assembly 70 is fixed to the insulative housing 10. The terminals 20 also include a second row of terminals 22 exposed upon the second surface 122 of the tongue portion 12. The second row of terminals 22 is inserted into the insulative housing 10, and the base portion 11 of the insulative housing 10 defines a channel 112 for the first row of terminals 21 and the second row of terminals 22 to go through. The channel 112 connects the first surface 121 and the second surface 122 of the tongue plate 12. The insulative housing 10 includes an insulative body 13 and an insulative frame 14 assembled together. The insulating base 13 includes the base portion 11 and the mating tongue portion 12, and the insulative frame 14 defines a frame opening 141 for accommodating the base portion 11.

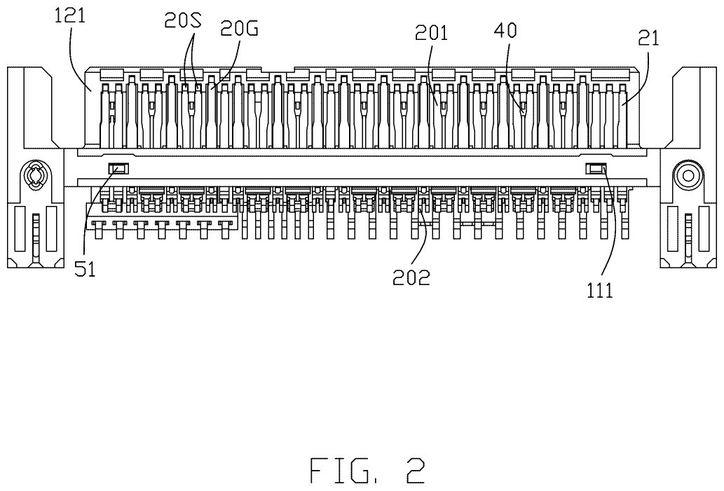

In this embodiment, the first grounding member 30, as shown in FIG. 2, the first surface 121 of the tongue portion 12 is at least partially removed between the two signal terminals of the differential signal terminal pair 20S and forming a recess, so that the insulative block 40 of the first grounding member 30 is exposed to the recess and proximal to the contact portion 201 of the signal terminal 20S.

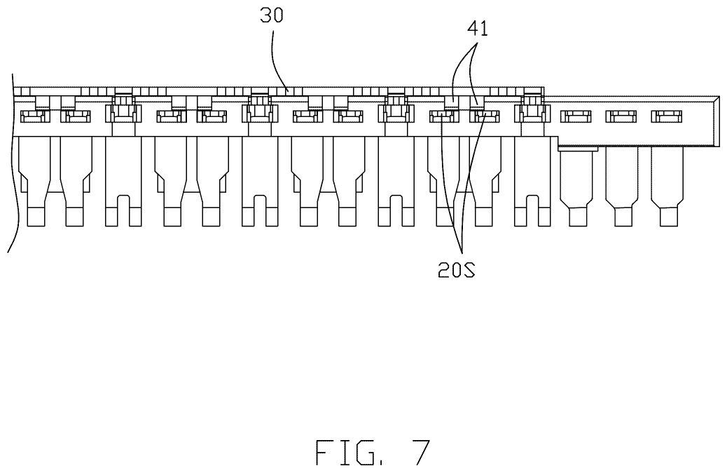

As shown in FIGS. 7-9, more specifically, the first grounding member 30 includes a plurality of shielding portions 31 and grounding portions 32 connected to the grounding terminal 20G. The adjacent shielding portions 31 are connected by a crossbeam 34, and the grounding portion 32 extends from the crossbeam 34 and connects to the grounding terminal 20G. Each shielding portion 31 includes an opening 33 and an insulative block 40 fixed inside the opening 33. The insulative block 40 is of an H-shaped structure, including a pair of insulative strips 41 facing the pair of differential signal terminals 20S and a crossbar 42 connected between the insulative strips 41. The pair of insulative strips 41 and the crossbar 42 are fixed in the opening by way of insert molding. The dielectric constant of the dielectric material of the insulative block 40 is lower than that of the tongue portion 12 to adjust impedence.

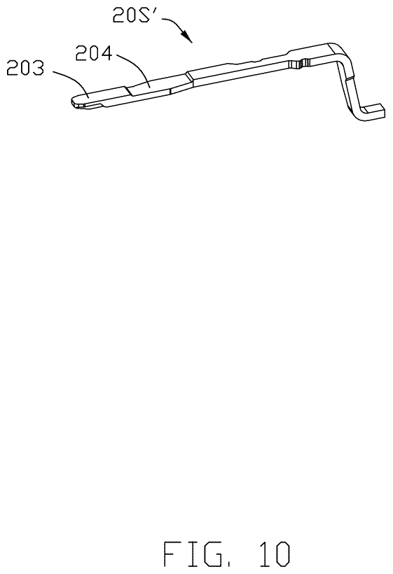

As shown in FIG. 10, it is the signal terminal 20S in another embodiment. The signal terminal 20S includes a contact portion 203 having a receding area 204 facing the surface of the tongue portion 12. The thinning area 204 does not pass through the front end of the contact portion 203 to improve the impedance effect.

1. An electrical connector comprising:
an insulative housing comprising a base portion and a tongue portion extending from the base portion in a mating direction, the tongue portion defining a first surface and a second surface opposite to the first surface;
a plurality of terminals comprising a first row of terminals exposed upon the first surface of the tongue portion and a second row of terminals exposed upon the second surface of the tongue portion; and
a first grounding member fixed between the first surface and the second surface;
wherein the first row of terminals comprise a grounding terminal and a pair of differential signal terminals and each include a contact portion exposed upon the first surface, the first grounding member includes a grounding portion contacting the grounding terminal and a shielding portion facing the pair of signal terminals, the shielding portion has an opening and an insulative block in the opening, and the insulative block is located adjacent to the contact portions of the signal terminals.

2. The electrical connector as claimed in claim 1, wherein the dielectric constant of the dielectric material of the insulative block is lower than that of the tongue portion.

3. The electrical connector as claimed in claim 2, wherein the first surface of the tongue portion has a recess aligned to the two signal terminals, so that the insulative block is exposed to the recess and faces the contact portions of the pair of differential signal terminals.

4. The electrical connector as claimed in claim 3, wherein the insulative block includes a pair of insulative strips facing the pair of differential signal terminals and a crossbar connected the insulative strips.

5. The electrical connector as claimed in claim 4, wherein the pair of insulative strips and the crossbar are fixed in the opening by way of insert molding.

6. The electrical connector as claimed in claim 1, wherein the first grounding member has at least two adjacent shielding portions connected to each other by a crossbeam, and the grounding portion extends from the crossbeam and presses against the grounding terminal.

7. The electrical connector as claimed in claim 1, wherein the first row of terminals is fixed together by an insulative body and the grounding portion of the first grounding member is welded and fixed to the grounding terminal of the first row of terminals.

8. The electrical connector as claimed in claim 7, wherein the base portion of the insulative housing defines a rearward-opening cavity, and the insulative body is inserted into the cavity and fixed to the cavity by means of snap-fit.

9. The electrical connector as claimed in claim 7, further comprising a second grounding member fixed on one side of the insulative body and extending out of the base portion, and including a plurality of shielding portions facing the two signal terminals and a grounding portion connected to the grounding terminal.

10. An electrical connector comprising:
an insulative housing comprising a base portion and a tongue portion;
a first row of terminals received in the insulative housing and comprising a pair of differential signal terminals and a grounding terminal exposed upon the tongue portion; and
a first grounding member comprising a grounding portion contacting the grounding terminal and a shielding portion shielding over the pair of differential signal terminals;
wherein each of the first row of terminals comprises a contact portion exposed upon a first surface of the tongue portion, and an insulative block extends from the shielding portion toward the contact portions of the pair of differential signal terminals.

11. The electrical connector as claimed in claim 10, wherein the dielectric constant of the dielectric material of the insulative block is lower than that of the tongue portion.

12. The electrical connector as claimed in claim 10, wherein the insulative block includes a pair of insulative strips facing the pair of differential signal terminals and a crossbar connected between the insulative strips.

13. The electrical connector as claimed in claim 12, wherein the shielding portion has an opening matching the shape of the insulative block and holding the insulative block in position, spaced apart from the contact portions of the pair of differential signal terminals by a distance.

14. The electrical connector as claimed in claim 10, wherein the contact portion of the signal terminal defines a receding area facing the surface of the tongue portion.

15. An electrical connector comprising:
an insulative housing including a base portion and a tongue portion;
a first row of terminals received in the insulative housing and comprising a pair of differential signal terminals and a grounding terminal exposed upon the tongue portion;
a first grounding member comprising a grounding portion fixed to the grounding terminal and a shielding portion shielding over the pair of signal terminals; and
an insulative block fixed in the shielding portion and facing the pair of differential signal terminals.

16. The electrical connector as claimed in claim 15, wherein the dielectric constant of the dielectric material of the insulative block is lower than that of the tongue portion.

17. The electrical connector as claimed in claim 15, wherein the grounding portion of the first grounding member is welded and fixed to the grounding terminal.

18. The electrical connector as claimed in claim 17, wherein the first row of terminals is fixed together by an insulative body.

19. The electrical connector as claimed in claim 18, wherein the base portion of the insulative housing defines a rearward-opening cavity, and the insulative body is inserted into the cavity and fixed to the cavity by means of snap-fit.

20. The electrical connector as claimed in claim 15, wherein the insulative block includes a pair of insulative strips facing the pair of differential signal terminals and a crossbar connected between the insulative strips.
